(19) United States
(12) Patent Application Publication
(10) Pub. No.: US 2026/0038105 A1
(43) Pub. Date: Feb. 5, 2026

(54) METHOD FOR FEEDING ORIENTED PARTS

(71) Applicant: AISAPACK HOLDING SA, Vouvry (CH)

(72) Inventor: Stéphane MATHIEU, Publier (FR)

(21) Appl. No.: 19/099,015

(22) PCT Filed: Aug. 17, 2023
(86) PCT No.: PCT/IB2023/058260

§ 371 Date: Jan. 27, 2025

(30) Foreign Application Priority Data
Aug. 19, 2022 (EP) 22191165.4

(51) Int. Cl. G06T 7/00; G06T 7/10; G06T 7/70

(52) U.S. Cl. CPC G06T 7/0004; G06T 7/10; G06T 7/70; G06T 2207/20081; G06T 2207/20084; G06T 2207/30164

(57) ABSTRACT

The method of feeding objects such as tube tops or caps comprises at least one orientation and quality inspection step integrated into the feeding method effected continuously during production, the orientation and quality inspection comprising a learning phase and a production phase.

### CORRESPONDING APPLICATION

The present application claims priority to earlier European application No. EP22191165.4 filed on Aug. 19, 2022 in the name of AISAPACK HOLDING SA, the content of this earlier application being incorporated by reference in its entirety in the present application.

### Field of the Invention

The invention is situated in the field of mass-produced objects necessitating high-throughput feed or distribution systems such as vibrating bowls or centrifugal bowls. The invention more particularly concerns a feed method and device utilising visual inspection and artificial intelligence algorithms to deliver oriented objects with a high production throughput.

### Prior Art

High-throughput feed systems that orient the objects are known in the prior art. Examples are given in the following publications: U.S. Pat. Nos. 5,311,977, 4,608,646, DE3312983, U.S. Pat. Nos. 4,692,881 and 5,853,078.

The publication U.S. Pat. No. 5,311,977 describes a system for feeding objects enabling determination of the orientation of the object by geometrical inspection and reorientation or rejection of the object with the aid of the output signal of a microprocessor. In that publication geometrical inspection is carried out by an object detector having at least 1000 pixels disposed in a linear manner that are oriented in such a manner as to be light or dark as a function of the geometry of the object. The system described in that publication comprises means enabling detection of points on the contour of the object located in a scanning tranche and comparison in real time of the position of the contour points with a memorised profile. The system enables the object to be oriented or rejected in response to the output signal of the microprocessor based on the contour point signals from a plurality of scanning tranches.

The publication U.S. Pat. No. 4,608,646 describes a microcontroller-based system for recognising and identifying identical or different objects transferred along the track of an object feeder, such as a bowl feeder, to verify the orientation of the objects and to sort the oriented objects in a predetermined repetitive sequence. Recognition and sequencing of the objects are programmable at the demand of the user. Recognition of the objects entails a device for recognising the silhouette of the objects, comprising a set of light sensors coupled to a perforated grid situated in the feed track. The image of the silhouette of each object to be sorted is first digitised and stored in the memory of the microcontroller in a position associated with an identification number of the object. Similarly, the sequence of different objects is stored in the memory of the microcontroller. Thereafter, when the objects are fed onto the grid, each object is compared to a corresponding stored image of the sequence in the correct position, incorrect or incorrectly oriented objects being rejected by a jet of air directed onto the feed track, whereas correct recognition of the object will lead to stopping of the jet of air, allowing the object to pass and to be delivered to a feed output station.

The publication DE3312983 describes a vibrating bowl for sorting mechanical components utilising the position and the contour of the components as a decision criterion. The apparatus comprises a transport device for transporting the components essentially perpendicularly to a line of electronic sensors by means of which their contours can be explored line by line and employs an electronic comparator to which the output signals from the line of sensors can be transmitted and by means of which they may be compared to previously memorised set point values.

The publication U.S. Pat. No. 4,692,881 describes a device for feeding objects in a predefined orientation. The device comprises a detector consisting of a plurality of light-receiving elements disposed in a single line or in a plurality of lines extending in a direction perpendicular to an object feed direction and at least one light-emitting element spaced from and facing the light-receiving elements. The device also comprises a random access memory (RAM) for memorising a reference signal model obtained by successively detecting the shape of objects as they pass in front of the detector in the preselected required position. The device also comprises a central processing unit (CPU) for comparing the reference signal model with the signal data model obtained when the objects to be discriminated pass successively in front of said detector in arbitrary positions. Incorrectly oriented objects are rejected into the bowl in response to each unfavourable comparison.

The publication U.S. Pat. No. 5,853,078 describes an apparatus for orienting and feeding objects that is particularly suitable for use in an automated assembly system. This apparatus comprises a feed bowl that comprises a helical internal track ending at the level of the upper edge of the bowl adjacent to an annular feed ring mounted for selective movement in rotation about the feed bowl. A control circuit including a fixed video camera positioned above the annular feed ring acts to control movement in rotation of the annular feed ring by a motor connected in an operational manner in order to bring successive parts of the annular feed ring into a predetermined field of view of the video camera in order for correctly oriented objects to be differentiated from incorrectly oriented objects, and a signal is thereafter supplied to a pick-and-place robot to remove the correctly oriented objects. A sweeper bar is positioned at a selected location to push incorrectly oriented objects out of the annular feed ring and to return them into the feed bowl for recycling. Another embodiment of the vibrating feed tank is also provided that utilises a second selective rotation disc in concentric and spaced relation to the feed ring to receive the recovered objects taken from the annular feed ring in receptacles provided on the ring.

### Objective, Constraints and Problems to be Solved

The present invention has the aim of reducing the time of adjustment of high-throughput systems such as vibrating bowls or centrifugal bowls for feeding oriented objects. Despite the improvements proposed in the prior art and described in particular in the publications U.S. Pat. Nos. 5,311,977, 4,608,646, DE3312983, U.S. Pat. Nos. 4,692,881 and 5,853,078, these systems do not enable rapid object changing, which leads to a great waste of time effecting the adjustments on each change of object. To overcome this difficulty vibrating or gravitational bowls are often dedicated to a unique object geometry because the time to change vibrating bowls on the assembly machines is shorter than the time to adjust the bowl to distribute the new object with the required throughput. This situation has the disadvantage of the investment in and storage of a large number of bowls for distributing objects that are individually adapted to a single object or to a limited number of objects.

Another disadvantage of the devices described in the prior art is linked to defective objects that are not detected. A defective object is for example an object that is deformed or out of tolerance or a product the aesthetic of which (for example its appearance) is unsuitable. These objects cause untimely stopping of the assembly machine or lead to defective assembled products.

The present invention makes it possible to remedy the aforementioned disadvantages thanks to a bowl provided with a vision system associated with artificial intelligence algorithms and possibly with orientation means. The invention also makes it possible to define criteria for rejection of so-called defective parts. The rejection criteria may be linked to the dimensions of the object, such as for example objects that are deformed or have dimensions outside the tolerances, or to aesthetic appearance defects (for example scratching, staining, foreign bodies, unsuitable colour, etc.).

In accordance with the present invention artificial intelligence algorithms associated with a vision system enable rapid changing of objects in a feed bowl with a high throughput of oriented objects. The invention also enables the rejection of defective objects, which avoids stopping the assembly machine if the objects are out of tolerance or deformed and also avoids the use of objects the aesthetic or the appearance of which is unsuitable.

In accordance with the present invention a learning phase enables definition of a “norm” of what is acceptable for the supplied objects. This “norm” defines a range of orientations of the object, where applicable an acceptable dimensional range and aesthetic range. In the context of the invention, the “acceptable or non-acceptable defect” concept, that is to say that of an object considered “good” or “defective”, is defined relative to a certain level of offset relative to the predefined norm established by learning.

The invention enables to guarantee a level of orientation and quality of the objects that is constant over time. Moreover, it is possible to reuse templates, that is to say norms already established beforehand, for later production of the same object.

The level of orientation and of quality of the objects may be adjusted by iterative learning over time as a function of the differences observed: during production the norm defined by the initial learning is refined by “supplementary” learning that takes account of the objects supplied in the normal production phase but having an orientation or defects considered acceptable. Consequently, it is necessary to adapt the norm in order for it to integrate this information and for the process not to reject these objects.

The invention enables distribution of objects in a very short time period and to obtain this performance relies on a model of compression-decompression of images of the objects as described in detail in the present application.

In the context of the present invention the constraints arising and the problems to be solved are in particular as follows:
Visual inspection is carried out during the movement of the object in the bowl and the inspection time is consequently reduced because it is not necessary to slow the production throughput or at the most the inspection has a low impact on the latter.
The range of acceptance of the oriented object must be adjustable.
Dimensional and aesthetic defects are not known (no defect library).
Aesthetic defects vary as a function of décor.
The level of acceptance of defects must be adjustable.
An object considered incorrectly oriented is an object the orientation of which is outside orientation tolerances considered acceptable.
An object considered defective is an object the defects of which are outside tolerances considered acceptable.

The method proposed by the invention described hereinafter enables the aforementioned disadvantages to be alleviated and the problems identified to be overcome.

### Definitions

Object: object being fed (or distributed) in a bowl, such as for example a cap or a tube top
N: number of objects forming a batch in the learning phase; N also corresponds to the number of secondary images forming a batch
Primary image: image captured of the object or of a part of the object
K: number of primary images per object
Aₖ: primary image with index k where 1≤k≤K
Secondary image: part of the primary image
Pₖ: number of secondary images per primary image
AₖS_{k,p}: secondary image with index k associated with the primary image Aₖ and index p where 1≤p≤Pₖ
F_{k,p} model: compression-decompression model associated with the secondary image S_{k,p}
Compression factor Q_{k,p}: compression factor of the model F_{k,p}
Reconstructed secondary image R_{k,p}: reconstructed secondary image reconstructed from the secondary image S_{k,p} using the associated model F_{k,p}

### General Description of the Invention

The invention relates to a method for feeding oriented objects, such as packaging components for example, such as tubes tops or caps, including visual inspection integrated into one or more steps of the method for distributing said objects. The feeding method according to the invention comprises at least two phases for carrying out the visual inspection:
A learning phase during which a batch of objects deemed “correctly oriented” and “of good quality” are fed and following which learning phase criteria are defined on the basis of the images of said objects.
A production phase during which the image of the objects being produced and the criteria defined during the learning phase are used to quantify in real time the orientation and quality of the objects being fed and to control the feeding process.
During the learning phase the machine feeds a number N of objects deemed of acceptable quality and orientation. One image (K=1) or a plurality of distinct images (K>1) referred to as primary images of each object is or are collected during the process of feeding said objects. The K×N primary images collected undergo a digital processing described in more detail hereinafter and including at least the following steps:
   Repositioning each primary image Aₖ
   Dividing each primary image Aₖ into Pₖ secondary images denoted S_{k,p} where 1≤k≤K and 1≤p≤Pₖ
   Grouping the secondary images into batches of N similar images
   For each batch of secondary images S_{k,p}:
      Seeking a compressed representation F_{k,p} with compression factor Q_{k,p}
      From each batch of secondary images, deducing a compression-decompression model F_{k,p} with a compression factor Q_{k,p}. One particular instance of the invention comprises having the same compression factor for all the models F_{k,p}. The adjustment of the compression factor Q_{k,p} for each model F_{k,p} enables adjustment of the level of detection of defects and optimisation of the calculation time as a function of the observed zone of the object.

At the end of the learning phase a model F_{k,p} and a compression factor Q_{k,p} are therefore available for each observed zone of the object, each zone being defined by a secondary image S_{k,p}.

As explained in more detail hereinafter each secondary image of the object has its own dimensions. A special case of the invention comprises having all the secondary images of identical size. In some cases it is advantageous to be able locally to reduce the size of the secondary images in order to detect smaller defects. By adjusting conjointly the size of each secondary image S_{k,p} and the compression factor Q_{k,p}, the invention enables optimisation of the calculation time whilst retaining a high level of detection performance adjusted to suit the level of requirement linked to the manufactured product. The invention enables local adaptation of the detection level to suit the level of criticality of the observed zone.

During the production phase K so-called “primary” images of each object are used for real-time monitoring of the orientation and quality of the objects being produced, which enables:
recycling into the feeder system of incorrectly oriented objects or correct orientation of said incorrectly oriented objects,
removing defective objects from production as soon as possible.

To effect real-time monitoring of the object being produced the K primary images of said object are evaluated by a method described in the present application relative to the group of primary images acquired during the learning phase from which are extracted the compression-decompression functions and the compression factors that are applied to the image of said object being produced. This comparison between images acquired during the production phase and images acquired during the learning phase leads to the determination of one or more scores per object, the values of which enable classification of the objects relative to thresholds corresponding to levels of orientation and levels of visual quality. Thanks to the value of the scores and to the predefined thresholds, incorrectly oriented objects are either recycled into the bowl or reoriented and defective objects can be discarded from the production process. Other thresholds may be used to detect batches of defective objects (reject rate too high) and to enable a change of batch of objects in order not to compromise the feeding throughput of oriented objects.

Part of the invention resides in the calculation of the scores that, thanks to a plurality of numerical values, enable quantification of the orientation and visual quality of the objects being produced. The calculation of the scores of each object being produced requires the following operations:
Acquiring the primary images Aₖ of the object being produced
Repositioning each primary image relative to the respective reference image
Dividing the K primary images into secondary images S_{k,p} using the same decomposition process as that used during the learning phase
Calculating the reconstructed image R_{k,p} of each secondary image S_{k,p} using the model F_{k,p} and the factor Q_{k,p} defined during the learning phase
Calculating the reconstruction error of each secondary image by comparing the secondary image S_{k,p} and the reconstructed secondary image R_{k,p} (with all of the secondary images of the object all of the reconstruction errors are obtained)
Calculating the scores of the object on the basis of the reconstruction errors

Using the numerical model F_{k,p} with the compression factor Q_{k,p} enables great reduction of the calculation time, monitoring of the orientation and quality of the object during the orientation and feeding process and control of the process. The method is particularly suited to methods of feeding oriented objects with a high production throughput.

The invention is advantageously used in the packaging field for feeding packaging components such as tube tops or caps, for example. The invention is particularly advantageous for high-throughput feeding of tube tops and caps on machines for producing tubes for so-called “oral care” or cosmetic products. The invention is particularly advantageous for feeding capping devices with caps.

The invention may be used in numerous assembly methods such as welding, gluing, clipping or screwing, for example. This is the case for example of the method of producing packaging tubes in which injected components (tube top or shoulder and cap) are assembled at a high rate by welding, clipping or screwing in order to form the tube. It is highly advantageous to control continuously the orientation and the aesthetic of the components fed to the assembly machine. This makes it possible to increase efficiency and to avoid defective products.

The invention mainly targets assembly methods on automated production lines. The invention is particularly suited to the manufacture of objects at a high production throughput such as objects produced in the packaging sector or any other sector having high production throughputs.

According to the invention the acceptable orientation is defined automatically on the basis of the learning phase. A defect library is not necessary, the learning phase enabling definition of objects acceptable in terms of their orientation, dimensions and aesthetic. An inadequate orientation and any defects are detected automatically during production once the learning procedure has been executed.

In some embodiments, the invention concerns a method for feeding oriented objects, for example packaging components such as tube tops or caps, by means of a feeder bowl, such as a vibrating or centrifugal bowl, said method including at least one orientation and quality inspection step integrated into the feeding method carried out continuously during production, said inspection being based on images of the objects captured during feeding and using artificial intelligence algorithms, and said inspection including a learning phase enabling definition of acceptable tolerances for the orientation and quality of the objects and a production phase during which only objects for which the orientation and quality are within said acceptable tolerances are fed.

In some embodiments, the learning phase may comprise at least the following steps:
producing N objects considered as having an acceptable orientation and quality (namely within tolerances considered acceptable);
capturing at least one reference primary image (Aₖ)of each of the N objects;
repositioning each reference primary image (Aₖ);
dividing each reference primary image (Aₖ)into (Pₖ)secondary reference images (S_{k,p});
grouping corresponding reference secondary images in batches of N images;
determining a compression-decompression model (F_{k,p}) with a compression factor (Q_{k,p}) per batch.

In some embodiments the production phase may comprise at least the following steps:
capturing at least one primary image of at least one object being produced;
dividing each primary image into secondary images (S_{k,p});
applying the compression-decompression model and the compression factor defined in the learning phase to each secondary image (S_{k,p}) to form a reconstructed secondary image (R_{k,p});
calculating the reconstruction error of each reconstructed secondary image R_{k,p};
assigning one or more scores per object on the basis of the reconstruction errors;
possibly calculating the orientation index;
determining whether the object being fed successfully passes the inspection of its orientation and quality or not on the basis of the scores assigned.

In some embodiments, if the orientation is not within the acceptable tolerances the object may be oriented to come within the acceptable tolerances or recycled into a distribution bowl for subsequent distribution.

In some embodiments, if the quality of the object is not within the acceptable tolerances the object may be discarded from the production batch. It may be rejected or its defect may be corrected in such a manner as to eliminate the defect that has been noticed (so as to come within the acceptable tolerances) and reintroduced into a production batch.

In some embodiments, after the step of acquiring at least one primary image (in the learning and/or production phase), the or each primary image may be repositioned.

In some embodiments, each primary image may be processed numerically, for example. The processing may for example rely on a numerical filter (such as the Gaussian blur filter) and/or edge detection and/or the application of masks to conceal certain zones of the image such as for example the background or areas of no interest.

In another embodiment, multiple analysis may be carried out on one or more primary images. Multiple analysis comprises applying a plurality of treatments simultaneously to the same primary image. Thus a “mother” primary image could give rise to a plurality of “daughter” primary images as a function of the number of analyses executed. For example, a “mother” primary image may be the object of a first treatment with a Gaussian filter generating a first “daughter” primary image and a second treatment with a Sobel filter generating a second “daughter” primary image. The two “daughter” primary images undergo the same numerical processing defined by the invention. Thus one or more scores can be associated with each “daughter” primary image.

Multiple analysis is of benefit if very different characteristics are looked for on the objects. Thus multiple analysis enables the analysis to be adapted to suit the characteristic looked for. This method enables more refined detection for each type of characteristic. The characteristics may be used to determine the orientation index of the object or to detect any defects.

In some embodiments, the compression factor may be between 5 and 500,000 inclusive, preferably between 100 and 10,000 inclusive.

In some embodiments, the compression-decompression function may be determined on the basis of a principal component analysis (PCA).

In some embodiments, the compression-decompression function may be determined by an auto-encoder.

In some embodiments, the compression-decompression function may be determined by the so-called orthogonal matching pursuit (OMP) algorithm.

In some embodiments, the reconstruction error may be calculated on the basis of the Euclidean distance and/or the Minkovsky distance and/or using the Tchebichev method.

In some embodiments, the score may correspond to the maximum value of the reconstruction errors and/or the mean value of the reconstruction errors and/or the weighted mean value of the reconstruction errors and/or the Euclidean distance and/or the p-distance and/or the Tchebichev distance.

In some embodiments, N may be equal to at least 10.

In some embodiments, at least two primary images may be captured, the primary images being of identical size or of different sizes.

In some embodiments, each primary image may be divided into P secondary images of identical size or of different sizes.

In some embodiments, the secondary images S may be juxtaposed with or without an overlap.

In some embodiments, some secondary images may be juxtaposed with an overlap and other secondary images juxtaposed without an overlap.

In some embodiments, the secondary images may be of identical size or of different sizes.

In some embodiments, the integrated inspection of orientation and quality may be effected at least once in the feeding process.

In some embodiments, the learning phase may be iterative and repeated during production with objects being fed in order to take account of a difference that is not considered an incorrect orientation or a defect.

In some embodiments, the positioning may comprise considering a predetermined number of points of interest and descriptors distributed over the image and determining the relative movement between the reference image and the primary image that minimises the superposition error at the level of the points of interest.

In some embodiments, the points of interest may be distributed in a random manner in the image or in a predefined zone of the image.

In some embodiments, the position of the points of interest may be predefined, randomly or otherwise.

In some embodiments, the points of interest may be detected by one of the following methods named “SIFT”, “SURF”, “FAST” or “ORB” and the descriptors defined by one of the methods named “SIFT”, “SURF”, “BRIEF” or “ORB”.

In some embodiments, the image may be repositioned with respect to at least one axis and/or the image repositioned in rotation about the axis perpendicular to the plane formed by the image and/or the image repositioned by the combination of a movement in translation and a movement in rotation.

In some embodiments, the value of the score may be used to discriminate an object considered incorrectly oriented from an object considered defective.

In some embodiments, a plurality of scores may be used to discriminate an object considered incorrectly oriented from an object considered defective.

In some embodiments, repositioning of the images and at least one score may be used to discriminate an object considered incorrectly oriented from an object considered defective.

In some embodiments, the points of interest and descriptors and at least one score may be used to discriminate an object considered incorrectly oriented from an object considered defective.

In some embodiments, the object considered incorrectly oriented may be recycled into the feeder system.

In some embodiments, the object considered incorrectly oriented may be oriented correctly before or after it leaves the feeder system. The orientation system is for example a robot or other equivalent means.

In some embodiments, the object considered defective may be discarded from the production batch. For example, discarding it from the production batch may be effected by a jet of air that diverts the object away from the production stream and ejects it into a reject bin. This object may either be “corrected” by elimination of its defect, enabling its introduction into a production batch, or merely rejected.

### DETAILED DESCRIPTION OF THE INVENTION

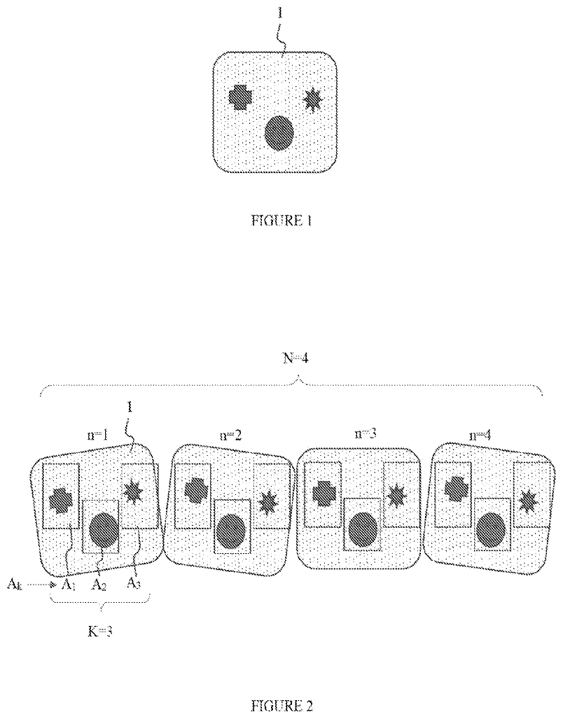

FIGS. 1 to 7 are used to illustrate the invention.

FIG. 1 illustrates an example of an object being fed in the bowl;

FIG. 2 illustrates primary images acquired during the learning phase;

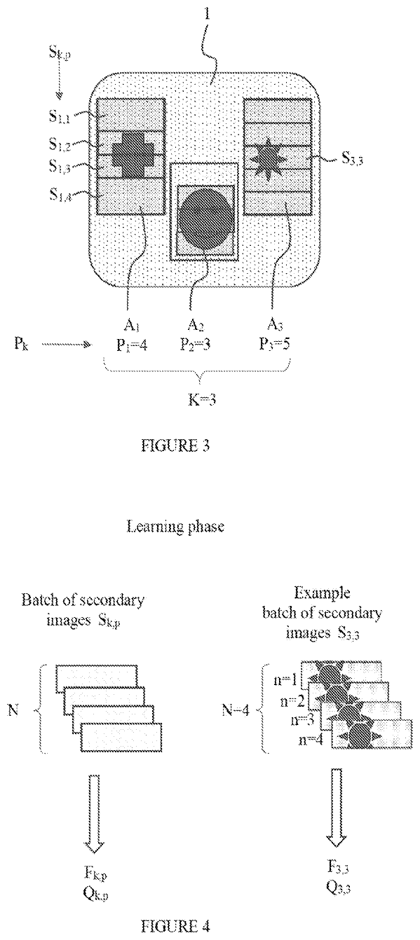

FIG. 3 illustrates cutting the primary images into secondary images;

FIG. 4 illustrates the learning phase and in particular the formation of batches of secondary images to obtain a compression-decompression model for each batch;

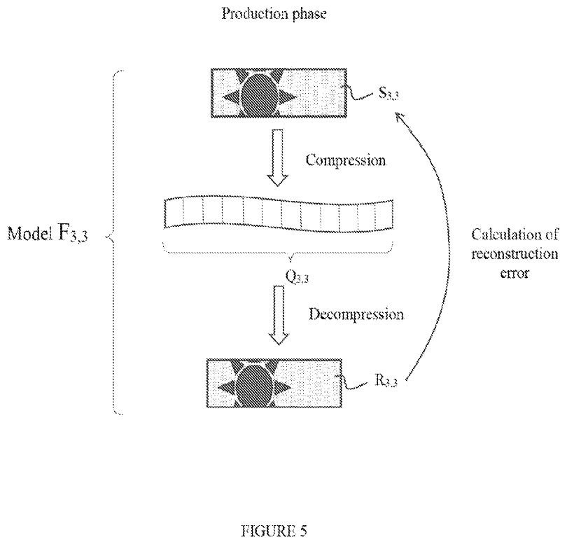

FIG. 5 illustrates the use of the compression-decompression model in the production phase;

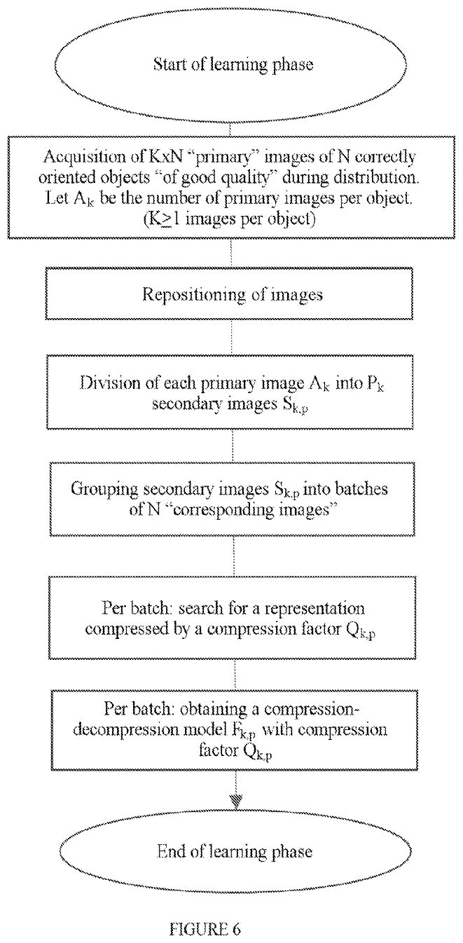

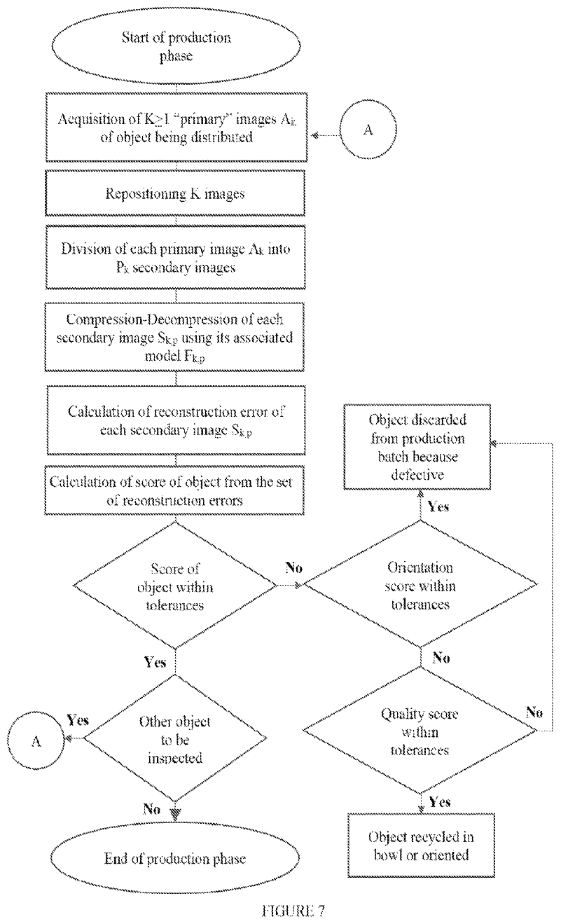

FIG. 6 illustrates in block diagram form the main steps of the learning phase;

FIG. 7 illustrates in block diagram form the main steps of the production phase.

FIG. 1 illustrates an object 1 being fed in a bowl with a high throughput. To illustrate the invention and to facilitate the understanding of the invention three decorative patterns have been represented on the object by way of non-limiting example. The invention enables monitoring of the orientation of the object and of the quality of these patterns on the objects being fed. The invention enables distribution and inspection of the oriented objects with a high production throughput. The invention enables rapid changing of the object intended to be fed with a reduced adjustment time. The objects may be considered unitary parts in the example shown in FIG. 1. The objects may for example be made of plastic material, metal, wood, glass or based on any other material or on a combination of these materials.

FIG. 2 illustrates an example of primary images of the object acquired during the learning phase. During that learning phase N objects judged correctly oriented and of acceptable quality are fed by the bowl. To facilitate the illustration of the invention only four objects have been represented in FIG. 2 by way of example. To obtain a robust model the necessary number of objects during the learning phase is greater than 10 (i.e. N>10) and preferably greater than 50 (i.e. N>50). Of course, these values are non-limiting examples and N may be less than or equal to 10. FIG. 2 shows three primary images A₁, A₂ and A₃ respectively representing distinct patterns printed on the object. In the description of the invention Aₖ designates the primary images of the object, the index k of the image varying between 1 and K, and K corresponding to the number of images per object.

As illustrated in FIG. 2 the size of the primary images Aₖ is not necessarily identical. In FIG. 2 the primary image A₂ is smaller than the primary images A₁ and A₃. This makes it possible for example to have an image A₂ with better definition (greater number of pixels). The primary images make up all of the surface of the object 1 or to the contrary cover its surface only partially.

As illustrated in FIG. 2 the primary images Aₖ target particular zones of the object. This flexibility of the invention as much at the level of the size as of the position and number of primary images enables optimisation of the calculation time whilst preserving very accurate inspection of visual quality in the most critical areas.

FIG. 3 illustrates the division of the primary images into secondary images. Accordingly, as illustrated in FIG. 3, the primary image A₁ is divided into four secondary images S_{1,1}, S_{1,2}, S_{1,3} and S_{1,4}. Thus each primary image Aₖ is decomposed into Pₖ secondary images S_{k,p} with the division index p varying between 1 and Pₖ.

As illustrated in FIG. 3, the size of the secondary images is not necessarily identical. By way of example FIG. 3 shows that the secondary images S_{1,2} and S_{1,3} are smaller than the secondary images S_{1,1} and S_{1,4}. This enables a more precise search for defects in the secondary images S_{1,2} and S_{1,3}.

As FIG. 3 also illustrates, the secondary images do not necessarily cover all of the primary image Aₖ. For example, the secondary images S_{2,p} cover the primary image A₂ only partially. By reducing the size of the secondary images the analysis is concentrated in a precise zone of the object. Only the zones of the object covered by the secondary images are analysed.

FIG. 3 illustrates the fact that the invention enables local adjustment of the observed zone of the object by adjusting the number, size and position of the secondary images S_{k,p}.

FIG. 4 illustrates the learning phase and in particular the formation of batches of secondary images to obtain a compression-decompression model with a compression factor for each batch.

FIG. 4 shows the grouping of the N similar secondary images S_{k,p} to form a batch. Each batch is processed separately and is used to create a compression-decompression model F_{k,p} with compression factor Q_{k,p}. By way of example and as illustrated in FIG. 3 the N=4 secondary images S_{3,3} are therefore used to create the model F_{3,3} with compression factor Q_{3,3}.

FIG. 5 illustrates the use in the production phase of the compression-decompression model obtained from the learning phase. In the production phase each model F_{k,p} determined during the learning phase is used to calculate the reconstructed image of each secondary image S_{k,p} of the object being fed in the bowl. Each secondary image of the object therefore undergoes an operation of compression-decompression with a different compression factor and model from the learning phase. A result of each compression-decompression operation is a reconstructed image that can be compared with the secondary image from which it is obtained. Comparing the secondary image S_{k,p} and its reconstructed image R_{k,p} enables calculation of a reconstruction error that will be used to define a score.

FIG. 5 illustrates by way of illustrative example the particular case of obtaining the reconstructed image R_{3,3} from the secondary image S_{3,3} using the model F_{3,3} and its compression factor Q_{3,3}.

FIG. 6 represents the main steps of the learning phase according to the present invention. At the start of the learning phase N objects judged correctly oriented and of acceptable quality are fed by the bowl. The qualitative and/or quantitative judgement of said objects may be carried out in accordance with visual inspection procedures or in accordance with methods and means defined by the user's business. The number of objects fed in the learning phase may therefore be equal to N or greater than N. The learning phase illustrated in FIG. 6 comprises at least the following steps:
Acquisition of the K×N so-called “primary” images of the objects judged correctly oriented and of good quality during distribution of said objects. Each object may be associated with one primary image (K=1) or a plurality of distinct primary images (K>1) depending on the dimensions of the zone to be analysed on the object and the size of the defects that it is wished to detect. Conditions of lighting and of magnification appropriate to the industrial context are used to enable the acquisition of images in a relatively constant luminous environment. Known lighting optimisation techniques may be employed to prevent reflection phenomena or disturbances linked to the environment. Multiple solutions routinely used may be adopted such as for example tunnels or black boxes that enable avoidance of disturbances to lighting coming from the outside and/or light with a specific wavelength and/or illumination at a grazing angle or indirect lighting. If a plurality of primary images are acquired on the same object (K>1) said primary images may be spaced, juxtaposed or overlap. Overlapping of the primary images may be useful if it is wished to avoid cutting out a possible defect that might appear between two images and/or to compensate the loss of information on the edge of the image linked to the image repositioning step. These approaches may equally well be combined as a function of the primary images and the information found therein. The image may equally be pre-treated by means of optical or numerical filters in order for example to improve contrast.
The primary images are then repositioned relative to a reference image. As a general rule, the primary images of any object fed during the learning phase may serve as reference images. The primary images of the first object fed during the learning phase are preferably used as reference images. The methods of repositioning the primary image are described in detail in the remainder of the description in the present application.
Each primary image Aₖ is then divided into Pₖ so-called “secondary” images. The division of the image may result in an analysis zone smaller than the primary image. A reduction of the size of the analysis zone may be of benefit if it is known a priori in which zone of the object to look for possible defects. The secondary images may be spaced from one another to leave between them “non-analysed” zones. This situation may be used for example if the defects appear in targeted zones or if the defects appear repetitively and continually. Reducing the size of the analysis zone makes it possible to reduce the calculation time. Alternatively, the secondary images may be overlapped. Overlapping the secondary images makes it possible to avoid cutting a defect into two parts if said defect appears at the join between two secondary images. Overlapping secondary images is particularly useful if small defects are looked for. Finally, the secondary images may be juxtaposed with no spacing and no overlap. The primary image may be divided into secondary images of identical or varying size and the manner of relative positioning of the secondary images (spaced, juxtaposed or superposed) may also be combined as a function of the defects looked for.
The next step comprises grouping the corresponding secondary images in batches. The secondary images obtained from the K×N primary images generate a set of secondary images. On the basis of this set of secondary images there may be formed batches containing N corresponding secondary images, namely the same secondary image S_{k,p} of each object. Thus the N secondary images S_{1,1} are grouped in one batch. The same applies for the N images S_{1,2} and then for the N images S_{1,3} and so on for all of the images S_{k,p}.
The next step comprises seeking a compressed representation for each batch of secondary images. This operation is a key step of the method according to the invention. It comprises in particular in obtaining a compression-decompression model F_{k,p} with compression factor Q_{k,p} that characterises said batch. The models F_{k,p} will be used for monitoring the quality of the objects during the production phase. Thus there is obtained the model F_{1,1} with compression criterion Q_{1,1} for the batch of secondary images S_{1,1}. Similarly the model F_{1,2} is obtained for the batch of images S_{1,2}, then the model F_{1,3} for the batch of images S_{1,3}, and so on, and thus the model F_{k,p} is obtained for each batch of images S_{k,p}.
The choice of the compression factor Q_{k,p} for each batch of secondary images S_{k,p} depends on the calculation time available and the size of the defect that it is wished to detect.
At the end of the learning phase there is available a set of models F_{k,p} with compression factor Q_{k,p} that are associated with the orientation and visual quality of the object being produced.

According to the invention the results of the learning phase, which comprise the models F_{k,p} and the compression factors Q_{k,p}, may be preserved as a “template” and reused subsequently during new production of the same objects. Objects of identical quality can therefore be reproduced subsequently by reusing the predefined template. This also makes it possible to avoid repeating the learning phase before starting each production run of the same objects.

According to the invention it is possible to use iterative learning during production. Thus it is possible during production for example to effect additional (or complementary) learning with new objects and to add the images of those objects to the images of the objects initially taken into account during the learning phase. A new learning phase may be effected on the basis of the new set of images. Learning that evolves is particularly suitable if a difference of orientation or a difference of aesthetic between the object appears during production and that difference is not considered a defect. In other words, these objects are to be considered “good” as in the initial learning phase and it is preferable to take account of this. In this situation iterative learning is necessary in order to avoid a high reject rate that would comprise objects with this difference. Iterative learning may be carried out in numerous ways, either for example by pooling the new images with the images captured previously or by restarting learning with the new acquired images or retaining only a few initial images with the new images.

In accordance with the invention iterative learning is triggered by an indicator linked to the rejection of objects. This indicator is for example the number of rejects per unit time or the number of rejects per quantity of objects fed. If this indicator exceeds a fixed value, the operator is alerted and decides if the increase in the rejection rate necessitates:
an iterative learning phase,
adjustment of the feed system,
rejection of the batch of objects.

FIG. 7 represents the main steps of the object production phase. The production phase starts after the learning phase, that is to say when the characteristic criteria of objects “correctly” oriented and of “acceptable” quality have been defined as described hereinabove. The invention enables recycling or orientation of objects considered incorrectly oriented, rejection from the production batch in real time of objects considered defective, and avoiding use of objects considered defective if drift in quality of the objects has been observed. The production phase according to the invention illustrated in FIG. 7 comprises at least the following operations:
Acquisition of K primary images of the object being fed in the bowl. The images of the object are captured in exactly the same way as the images captured in the learning phase: the zones photographed, lighting, magnification and adjustment conditions are identical to those used during the learning phase.
The K images are repositioned relative to the reference images. The aim of the repositioning operation is to avoid offsets between the images that it is wished to compare. These offsets are linked to variations of position and of orientation of the objects during imaging.
Each primary image Aₖ of the object being produced is then divided into Pₖ secondary images. Division is effected in the same manner as the division of the images in the learning phase. Following this division there is therefore obtained a set of secondary images S_{k,p} for each object being produced.
Each secondary image S_{k,p} is then compressed-decompressed using the model F_{k,p} with compression factor Q_{k,p} predefined during the learning phase. This operation generates a reconstructed image R_{k,p} for each secondary image S_{k,p}. Thus for the object being produced reconstructed images are obtained that can be compared to the secondary images of said object. From the numerical point of view, the term “reconstruction of the secondary image” does not necessarily mean obtaining a new image in the strict sense of the term. The objective is to compare the image of the object being produced to the images obtained during the learning phase using the compression-decompression functions and compression factors, only the quantification of the difference between these images being strictly useful. For reasons of calculation time the choice may be made to limit calculation to a numerical object representative of the reconstructed image and sufficient to quantify the difference between the secondary image and the reconstructed image. The use of the model F_{k,p} is particularly advantageous as it makes it possible to effect this comparison in very short times compatible with what is required and production throughputs.
A reconstruction error can be calculated based on the comparison of the secondary image and the reconstructed secondary image. The preferred method for quantifying this error is to calculate the mean squared error but other equivalent methods are possible.
For each object there are therefore available secondary images and reconstructed images, and consequently reconstruction errors. A plurality of scores can be defined for the object being produced based on this set of reconstruction errors. A plurality of calculation methods are possible for calculating the scores of the object that characterise its resemblance to or difference from the learned batch. Thus according to the invention an object visually very different from the learning batch because it has a different orientation or defects will have one or more high scores. A contrario, an object visually very similar to the learning batch will have one or more low scores and will be considered correctly oriented and of good quality (or of acceptable quality). A third method for calculating the score or scores of the object comprises taking the maximum value of the reconstruction errors. Other methods comprise combining the reconstruction errors to calculate the value of the score or scores of the object.
The next step comprises recycling or correctly orienting “incorrectly oriented” objects and discarding defective objects from the production batch. If the value of the score or scores of the object is below a predefined limit or limits the evaluated object complies with the orientation and visual quality criteria defined during the learning phase and the object remains in the production stream. A contrario, if the value or values of the score or scores of the object is or are greater than said limit or limits either the object is recycled into the feeder system (or oriented) because its orientation is outside the acceptable range or the object is discarded from the production stream because it is defective and recycling it is of no utility.

A plurality of methods may be used to differentiate an incorrectly oriented object from a defective object:
A first method comprises using the value of the score to discriminate an incorrectly oriented object from a defective object.
In accordance with another method a plurality of scores are used to discriminate an incorrectly oriented object from a defective object.
In accordance with another method repositioning the images and at least one score are used to discriminate an incorrectly oriented object from a defective object.
In accordance with another method the points of interest and descriptors and at least one score are used to discriminate an incorrectly oriented object from a defective object.

The steps of the invention are returned to and described in more detail hereinafter.

### Repositioning the Primary Image

The method in accordance with the invention for repositioning the image comprises two steps:
Searching the image for points of interest and descriptors
Repositioning the captured image relative to the reference image on the basis of the points of interest and descriptors and deducing the orientation of the object

The reference image or images is/are typically defined on the first image captured during the learning phase or another image, as described in the present application. The first step comprises defining on the image points of interest and descriptors associated with the points of interest. The points of interest may for example be angular parts at the level of the shapes present in the image; they may further be zones of high contrast or colour or the points of interest may be chosen at random. The points of interest identified are then characterised by descriptors that define the characteristics of those points of interest.

The points of interest are preferably determined automatically using an appropriate algorithm but an alternative method comprises arbitrarily predefining the position of the points of interest.

The number of points of interest used for repositioning varies and depends on the number of pixels per point of interest. The total number of pixels used for positioning is generally between 100 and 10,000 inclusive and preferably between 500 and 1,000 inclusive.

A first method for defining the points of interest comprises choosing those points at random. This amounts to defining at random a percentage of pixels termed points of interest, the descriptors being the characteristics (position, colour) of said pixels. This first method is particularly suited to the context of industrial production, above all in the situation of production processes with high throughput where the time available for the calculation is very short.

In accordance with a first embodiment of the first method the points of interest are randomly distributed in the image.

In accordance with a second embodiment of the first method the points of interest are randomly distributed in a predefined zone of the image. This second embodiment is advantageous when it is known a priori where any defects will appear.

A second method for defining the points of interest is based on the named “scale invariant feature transform (“SIFT”) method” (see the publication U.S. Pat. No. 6,711,293) i.e. a method that makes it possible to preserve the same visual characteristics of the image independently of the scale. This method comprises calculating the descriptors of the image at the points of interest of said image. These descriptors correspond to numerical information derived from the local analysis of the image that characterises the visual content of the image independently of the scale. The principle of this method comprises detecting in the image defined zones around points of interest, said zones preferably being circular with a radius termed the scale factor. In each of these zones the shapes and their contours are looked for, after which the local orientations of the contours are defined. Numerically, these local orientations result in a vector that constitutes the SIFT descriptor of the point of interest.

A third method for defining the points of interest is based on the “speeded up robust features (“SURF”) method” (see the publication US 2009/0238460) i.e. an accelerated method for defining the points of interest and descriptors. This method is similar to the SIFT method but has the advantage of speed of execution. Like the SIFT method this method comprises a step of extracting the points of interest and calculating the descriptors. The SURF method uses Fast Exact Multiplication by the Hessian to detect the points of interest and an approximation of the Haar wavelets to calculate the descriptors.

A fourth method for looking for the points of interest based on the features from the “features accelerated segment test (“FAST”) method” comprises identifying the potential points of interest and then analysing the intensity of the pixels situated around said points of interest. This method enables very rapid identification of the points of interest. The descriptors can be identified using the “binary robust independent elementary features (“BRIEF”) method”.

The second step of the method of repositioning the image comprises comparing the primary image to the reference image using the points of interest and their descriptors. The best repositioning is achieved by looking for the best alignment between the descriptors of the two images.

In the present instance, the image may necessitate repositioning with respect to only one axis or with respect to two perpendicular axes or repositioning in rotation about the axis perpendicular to the plane formed by the image.

The repositioning of the image may be the result of combining movements in translation and in rotation. The optimum homographic transformation is looked for employing the least squares method.

The points of interest and descriptors are used in the operation of repositioning the image. These descriptors may for example be the characteristics of the pixels or the SIFT, SURF, BRIEF descriptors. The points of interest and the descriptors are used as marker points for repositioning the image.

In the SIFT, SURF and BRIEF methods repositioning is effected by comparing the descriptors. The descriptors that are not pertinent are discarded using a consensus method such as the Ransac algorithm for example. The optimum homographic transformation is then looked for using the least squares method.

### Division of the Primary Image Into Secondary Images

The primary image can be divided into P secondary images in several ways.

A benefit of the invention is to enable adjustment of the visual analysis level to suit the observed zone of the object. This adjustment is carried out as a first step based on the number of primary images and the level of resolution of each primary image. Decomposition into secondary images then enables adjustment of the analysis level locally in each primary image. A first parameter that can be operated on is the size of the secondary images. A smaller secondary image enables local refinement of the analysis. By conjointly adjusting the size of each secondary image S_{k,p} and the compression factor Q_{k,p} the invention enables optimisation of the calculation time whilst retaining a high performance detection level adjusted to suit the level of requirement linked to the object delivered. The invention enables local adaptation of the detection level to the level of criticality of the observed zone.

One particular instance of the invention comprises all the secondary images being the same size.

Accordingly, when all of the observed zone is equally important a first method comprises dividing the primary image into P secondary images of identical size juxtaposed with no overlap.

A second method comprises dividing the primary image into P secondary image of identical size that are juxtaposed with an overlap. The overlap is adjusted as a function of the size of the defects liable to appear on the object.

The smaller the defect, the smaller the overlap may be. It is generally considered that the overlap is at least equal to the characteristic half-length of the defect, the characteristic length being defined as the smallest diameter of the circle able to contain the entire defect.

Of course, it is possible to combine these methods and to use secondary images that are juxtaposed and/or with an overlap and/or at a distance from one another.

### Calculation of the Compression-Decompression Functions

In accordance with a first method that is also the preferred method the compression-decompression functions and the compression factors are determined based on a principal component analysis (PCA). This method enables definition of the eigen values and vectors that characterise the batch resulting from the learning phase. In the new base the eigen vectors are classed by order of size. The compression factor stems from the number of dimensions retained in the new base. The higher the compression factor the smaller the number of dimensions in the new base. The invention enables adjustment of the compression factor as a function of the level of inspection required and as a function of the available calculation time.

A first advantage of this method is linked to the fact that the machine requires no indication to define the new base. The eigen vectors are chosen automatically by calculation.

A second advantage of this method is linked to the reduction of the calculation time for detecting defects in the production phase. The quantity of data to be processed is reduced because the number of dimensions is reduced.

A third advantage of the method is the possibility of assigning one or more scores in real time to the image of the object being produced. The score or scores obtained enable(s) quantification of a deviation/error level of the object being fed in the bowl relative to the objects from the learning phase by way of its reconstruction using the models from the learning phase.

The compression factor is between 5 and 500,000 inclusive and preferably between 100 and 10,000 inclusive. The higher the compression factor the shorter the calculation time to analyse the image in the production phase. However, too high a compression factor may lead to a model that is too coarse and unsuitable for detecting errors.

In accordance with a second method the model is an auto-encoder. The auto-encoder takes the form of a neural network that enables the characteristics to be defined in an unsupervised manner. The auto-encoder comprises two parts: an encoder and a decoder. The encoder makes it possible to compress the secondary image S_{k,p} and the decoder makes it possible to obtain the reconstructed image R_{k,p}.

In accordance with the second method an auto-encoder is available for each batch of secondary images. Each auto-encoder has its own compression factor.

In accordance with the second method the auto-encoders are optimised during the learning phase. The auto-encoder is optimised by comparing the reconstructed images and the initial images. This comparison enables quantification of the differences between the initial images and the reconstructed images and consequently determination of the encoder error. The learning phase enables optimisation of the auto-encoder by minimising the image reconstruction error.

In accordance with a third method the model is based on the “orthogonal matching pursuit (“OMP”) algorithm”. This method comprises looking for the best linear combination based on the orthogonal projection of a few images selected in a library. The model is obtained by an iterative method. The recomposed image is improved each time that an image from the library is added.

In accordance with the third method the image library is defined by the learning phase. This library is obtained by selecting a few images representative of the set of images from the learning phase.

### Calculation of the Reconstructed Image From the Compression-Decompression Model

In the production phase each primary image Aₖ of the object being inspected is repositioned using the methods described hereinabove and then divided into Pₖ secondary images S_{k,p}. Each secondary image S_{k,p} is subjected to a numerical reconstruction operation using its model as defined in the learning phase. At the end of the reconstruction operation there is therefore a reconstructed image R_{k,p} available for each secondary image S_{k,p}.

The operation of reconstructing each secondary image S_{k,p} using a model F_{k,p} with compression factor Q_{k,p} enables very short calculation times. The compression factor Q_{k,p} is between 5 and 500,000 inclusive and preferably between 10 and 10,000 inclusive.

In accordance with the PCA method, which is also the preferred method, the secondary image S_{k,p} is first transformed into a vector. This vector is then projected into the eigen vector base using the function F_{k,p} defined during the learning phase. The reconstructed image R_{k,p} is then obtained by transforming the vector obtained into an image.

In accordance with the second method the secondary image is recomposed by the auto-encoder, the parameters of which were defined in the learning phase. The secondary image S_{k,p} is processed by the auto-encoder in order to obtain the reconstructed image R_{k,p}.

In accordance with the third method the secondary image is reconstructed using the orthogonal matching pursuit (OMP) algorithm, the parameters of which were defined during the learning phase.

### Calculation of the Reconstruction Error of Each Secondary Image

The reconstruction error is obtained by comparing the secondary image S_{k,p} and the reconstructed image R_{k,p}.

One method used to calculate the error comprises measuring the distance between the secondary image S_{k,p} and the reconstructed image R_{k,p}. The preferred method used to calculate the reconstruction error is the Euclidean distance or 2-norm method. This method considers the square root of the sum of the squares of the errors.

An alternative method for calculating the error comprises using the Minkowsky distance, the p-distance that is a generalisation of the Euclidean distance. This method considers the p^{th} root of the sum of the absolute values of the errors to the power p. This method enables greater weight to be assigned to the large differences by choosing a value of p greater than 2.

Another alternative method is the Tchebichev or 3-norm method. This method considers the maximum absolute value of the errors.

### Calculation of the Score or Scores

The value of the score or scores of the object is obtained from the reconstruction error of each secondary image.

A preferred method comprises assigning to the score the maximum value of the reconstruction errors.

An alternative method comprises calculating the value of the score by obtaining the mean value of the reconstruction errors.

Another alternative method comprises obtaining a weighted average of the reconstruction errors. The weighted average may be useful if the criticality of the defects is not identical in all the zones of the object.

Another method comprises using the Euclidean distance or 2-norm.

Another method comprises using the p-distance.

Another method comprises using the Tchebichev distance or 3-norm.

Other equivalent methods are of course possible in the context of the present invention.

Once the score or scores has or have been calculated the value(s) thereof is/are used to determine whether the object concerned meets the required quality and orientation conditions or not. If so it is retained in the feed stream. If the score does not satisfy the conditions because the orientation of the object is outside the acceptable range the object is recycled in the feed system or reoriented. If the score does not satisfy the conditions because the object is defective the object is discarded from the feed process.

An incorrectly oriented object can be distinguished from a defective object on the basis of the value of the score. Thus, for example, for an incorrectly oriented (upside down) cap the score varies between 7 and 10 whereas cap defects generate a score between 3 and 5. Thus upside-down caps can easily be distinguished from defective caps.

In other cases it is proposed to use a plurality of scores to discriminate defective objects from incorrectly oriented objects. In particular, the invention makes it possible to define a score for a local zone of the object that is off-centre. Consider for example an object including an off-centre orifice. The local image of the orifice enables a score to be obtained linked to the orientation of the object. Combining the score of the orifice with other scores therefore makes it possible to separate badly oriented objects from defective objects.

In accordance with an alternative method the information on repositioning the objects and the score or scores are used to discriminate an incorrectly oriented object from a defective object.

In accordance with another method the points of interest and descriptors are used together with at least one score to discriminate an incorrectly oriented object from a defective object.

The incorrectly oriented object is preferably recycled in the bowl. A first method comprises blowing the component into the bowl by means of at least one jet of air on the trajectory of the object. An alternative method comprises expelling the component mechanically into the bowl by means of a piston and cylinder. The system enables recycling of the object by an air jet or by mechanical actuation.

In other embodiments the orientation of the incorrectly oriented object is corrected before or after the object leaves the bowl. Numerous object orientation systems may be envisaged and associated with the invention. These systems may comprise one or more axes as a function of the complexity of the orientation movement to be carried out. The orientation system is for example a robot.

In the present example it must be clearly understood that the method is implemented in a feed system (such as a vibrating bowl or a centrifugal bowl) that can have a high throughput (for example at least 100 products per minute). If in the examples the singular has been used to define an object being produced, that is for simplicity. Indeed, the method applies to successive objects in a production feeder: the method is therefore iterative and repetitive on each successive object being fed and the orientation and quality are checked on all said successive objects.

The embodiments described are described by way of illustrative example and must not be considered limiting on the invention. Other embodiments may rely on means equivalent to those described, for example. The embodiments may equally be combined with one another as a function of circumstances or means and/or steps of the method used in one embodiment may be used in another embodiment of the invention.

1. Method for feeding by means of a feeder bowl, such as a vibrating or centrifugal bowl, oriented objects, for example packaging components such as tube tops or caps, said method including at least one orientation and quality inspection step integrated into the feeding method carried out continuously during production,
said inspection being based on images of the objects captured during feeding and using artificial intelligence algorithms,
said inspection including a learning phase enabling definition of acceptable tolerances for the orientation and quality of the objects and a production phase during which only objects for which the orientation and quality are within said acceptable tolerances are fed wherein said learning phase comprises at least the following steps:
producing N objects considered as having an orientation and quality within acceptable tolerances;
capturing at least one reference primary image (Aₖ)of each of the N objects;
dividing each reference primary image (Aₖ)into (Pₖ)secondary reference images (S_{k,p});
grouping corresponding reference secondary images in batches of N images;
determining a compression-decompression model (F_{k,p}) with a compression factor (Q_{k,p}) per batch,
and said production phase comprises at least the following steps:
capturing at least one primary image of at least one object being produced;
dividing each primary image into secondary images (S_{k,p});
applying the compression-decompression model and the compression factor defined in the learning phase to each secondary image (S_{k,p}) to form a reconstructed secondary image (R_{k,p});
calculating the reconstruction error of each reconstructed secondary image R_{k,p};
assigning one or more scores per object on the basis of the reconstruction errors;
determining whether the object being fed successfully passes the inspection of its orientation and its quality or not on the basis of the score or scores assigned.

2. Method according to claim 1 in which if the object is considered incorrectly oriented said object is oriented to come within the acceptable tolerances or recycled in a feeder bowl.

3. Method according to claim 1 in which if the object is considered defective said object is discarded from the production batch.

4. Method according to claim 1 in which the value of the score is used to discriminate a correctly oriented object from a defective object.

5. Method according to claim 1 in which a plurality of scores are used to discriminate a correctly oriented object from a defective object.

6. Method according to claim 1 in which a multiple analysis is effected on at least one of the primary images initially captured, said multiple analysis generating “daughter” primary images that are used in place of the image initially captured at their source.

7. Method according to claim 1 in which after the step of acquiring at least one primary image each primary image is repositioned.

8. Method according to claim 1 in which each primary image is processed using a filter and/or detection of contours and/or application of masks to conceal certain zones of the image.

9. Method according to claim 1 in which the score corresponds to the maximum value of the reconstruction errors and/or to the mean value of the reconstruction errors and/or to the weighted average of the reconstruction errors and/or to the Euclidean distance and/or to the p-distance and/or to the Tchebichev distance, said distance being between the secondary image S_{k,p} and the reconstructed image R_{k,p}.

10. Method according to claim 1 in which at least two primary images are captured, the primary images being of identical size or of different sizes.

11. Method according to claim 1 in which each primary image is divided into P secondary images S of identical size or of different sizes, the secondary images S being juxtaposed with and/or without an overlap.

12. Method according to claim 1 in which the learning phase is iterative and repeated during production with objects being fed in order to take account of any difference that is considered an acceptable orientation or quality defect.

13. Method according to claim 1 in which a repositioning step is carried out, wherein said repositioning step comprises considering a predetermined number of points of interest and descriptors distributed over the image and determining the relative movement between the reference image and the primary image that minimises the superposition error at the level of the points of interest and the points of interest are distributed randomly in the image or in a predefined zone of the image, the position of the points of interest being predefined, arbitrarily or otherwise.

14. Method according to claim 13 in which the image is repositioned on at least one axis and/or the image is repositioned in rotation about the axis perpendicular to the plane formed by the image and/or the image is repositioned by the combination of a movement in translation and a movement in rotation.

15. Method as claimed in claim 1 in which repositioning the images and at least one score are used to discriminate an incorrectly oriented object from a defective object or the points of interest and descriptors and at least one score are used to discriminate an incorrectly oriented object from a defective object.
